(19) United States
(12) Patent Application Publication
(10) Pub. No.: US 2024/0346872 A1
(43) Pub. Date: Oct. 17, 2024

(54) ON-PREMISES SMARTBOX

(71) Applicant: PT INTERMEDIATE HOLDINGS IV, LLC, Addison, IL (US)

(72) Inventor: Robert Patrick Ritacco, Truro (CA)

(21) Appl. No.: 18/581,879

(22) Filed: Feb. 20, 2024

Related U.S. Application Data
(60) Provisional application No. 63/447,164, filed on Feb. 21, 2023.

(51) Int. Cl. G07F 11/46; G06K 7/10; G06Q 10/087; G07F 9/00

(52) U.S. Cl. CPC G07F 11/46; G06K 7/10425; G06Q 10/087; G07F 9/001; G07F 9/002

(57) ABSTRACT

The invention is a system including a network of portable vending containers configured to provide on-site storage and vending services.

### CROSS-REFERENCE TO RELATED APPLICATIONS

This application claims priority to, and the benefit of, U.S. Provisional Application No. 63/447,164, filed Feb. 21, 2023, the content of which is incorporated by reference herein in its entirety.

### TECHNICAL FIELD

The invention generally relates to product distribution techniques and systems, and, more particularly, to a system including a network of portable vending containers configured to provide on-site storage and vending services, most notably for businesses and the like.

### BACKGROUND

Typically, when a business needs a certain item or part necessary in providing given services, that business would either have to work with a supplier to purchase the required item or place an order online for that item to be delivered. While purchasing inventory by way of placing a phone or online order can have its advantages, conventional methods of purchasing goods can have drawbacks. For example, depending on the inventory levels, it may take too long for an item ordered by phone or online to finally reach the business when they have immediate needs. This is particularly troublesome when the need for a specific item arises at the eleventh hour and time is of the essence, such as in the event of equipment breakdown and repair part(s) are crucial. Furthermore, certain businesses that regularly consume parts as part of their revenue generation may be plagued with inventory shortages when attempting to run their business (i.e., landscaping, construction, other trades, etc.).

### SUMMARY

The present invention is directed generally to a portable vending container for providing on-site storage and vending services. In particular, the portable vending container provides an enclosure for housing a plurality of items of inventory that are available on-demand.

The container includes a locking mechanism configured to communicate and transmit data with an internet-based asset management platform, over a network. When the locking mechanism is in a locked state, the items of inventory are inaccessible and thus maintained in a secured fashion. However, the locking mechanism is configured to transition to an unlocked state in response to receiving a signal associated with a purchase transaction, specifically a user purchase or rental of one or more items of inventory stored within the container (which is based on user interaction with an interface on the user's computing device provided via the asset management platform). As such, when the user purchases or rents one or more items of inventory via their computing device (i.e., tablet or smartphone), the internet-based asset management platform communicates and transmits data over the network to the locking mechanism. Upon receiving data from the asset management platform, the locking mechanism transitions from a locked state to an unlocked state, thereby making the inventory accessible to the user.

The portable vending container includes a communication module allowing for wireless communication and transition of data between the locking mechanism and other components associated with the vending container and also the asset management platform. In particular, the communication module may be WiFi-enabled which allows the container and the other components associated with the vending container to be connected to a wireless network.

Any given item of inventory within the container may be radio-frequency identification (RFID) enabled to allow for recognition and subsequent movement (i.e., vending, replenishing, etc.) of a given good. In other words, each item of inventory within the container may have its own RFID tag. Furthermore, the container comprises at least one RFID antenna and reader. In the event that the user purchases or rents an item of the inventory within the container, the locking mechanism of the container unlocks. As the user removes the purchased item from the container, the RFID reader communicates with the RFID tag on the item. The user is then charged or the item purchased or rented.

It should be noted that weight of all items of the inventory present within the vending container is recorded using a scale. Upon purchasing and subsequently removing one or more item from the container, the scale records the weight of one or more items removed from the container. Therefore, by incorporating a scale, the container is configured to determine whether there is a positive correlation with a reference weight of the item. In other words, the vending container is configured to verify as to whether the one or more items purchased through the asset management platform are the items that were removed from the container.

For example, the vending container may include a plurality of stacked trays and/or shelves, such that the inventory is provided within respective trays. The weighing scale may record the weight of each item carried by each tray such that each item has its own reference weight. Once one or more items from a specific tray are purchased and removed, the weighing scale records the weight of the tray. A positive correlation is then made to the reference weight of the item purchased.

To further verify the identity of one or more items being removed, the container comprises a camera to record one or more pictures of the items removed. Removal of one or more items purchased from the container concludes the transaction and the container relocks.

In the event that a user is returning a rental item or because the user purchased an incorrect item, the container is configured to operate generally in a similar manner as when one or more item is vended to the use (i.e., when an item is purchased and is being picked up). For example, the user may initiate the return of an item via the internet-based asset management platform. The internet-based asset management system communicates and transmits data to the locking mechanism and, upon data transmission, the locking mechanism unlocks and the user can then return the item to the container. The scale then measures the weight of the item being returned. Measuring the weight enables verifying that the item being returned is indeed the item that was purchased. The scale is configured to make a positive correlation between the item the user purchased with the item being returned in order to make the verification. To further verify that the item being returned is the correct item, the camera records one or more pictures of the item being returned. Furthermore, as the item is being placed by the user in the container, the RFID reader communicates with the RFID tag on the item and a refund of the amount charged to the user is initiated.

In addition to vending goods and accepting returned goods, the inventory of a given container is configured to be replenished. More specifically, the specific inventory of any given container can be managed by the asset management platform. It may be determined at any given time that certain items need to be replenished (i.e., the number of available items is low in a given container). As such, items can be delivered on-site to a customer associated with that given site, and, in turn, the customer can interact with the interface to initiate an inventory replenishment and then physically place such items into the container. Again, by use of the scale, camera, and RFID tag reading, the container is able to verify that the items have been placed within the container and the inventor has been replenished.

Accordingly, the vending container of the present invention provides a number of advantages over current options. In particular, the container is configured to cooperatively function with an internet-based asset management platform and thus enable users to browse, purchase, rent, and/or return items at their convenience, particularly those items that are most essential to the business and the type of work that is being performed on-site.

### BRIEF DESCRIPTION OF THE DRAWINGS

FIG. 1 is a block diagram illustrating one embodiment of an exemplary system for providing a business with access to a network of vending containers configured to vend goods to users (workers, employees, etc.) on-site and on-demand.

FIG. 2 is a block diagram illustrating the asset management platform of FIG. 1 in greater detail.

FIG. 3 is a block diagram illustrating at least one embodiment of a computing device (i.e., mobile device) for communicating with the asset management platform and providing an interface upon which the user can interact so as browse and either purchase or rent goods from the vending container.

FIG. 4 is a block diagram illustrating communication and exchange of data between a mobile device of a worker or employee of a business, the asset management platform, and the vending container consistent with the present disclosure.

FIG. 5 is a perspective view of an exemplary embodiment of a vending container consistent with the present disclosure.

FIG. 6A is a perspective view of the vending container in which the locking mechanism (see FIG. 6B) is a locked state, in which the plurality of items of inventory within the container are inaccessible. FIG. 6B is an enlarged view of a portion of the vending container of FIG. 6A, illustrating the locking mechanism.

FIG. 7A is a perspective view of the vending container in which the locking mechanism transitioned to an unlocked state (in response to transaction data received from the asset management platform and based on a user's purchase/rental of one or more items from the inventory) and one or more purchased/rented items are accessible and able to be removed from the container. FIG. 7B is a screenshot of a user's smartphone indicating that the purchased/rented items have been successfully removed from the container, thereby allowing for the transaction to be completely processed.

### DETAILED DESCRIPTION

By way of overview, the present invention is directed to a portable vending container configured to provide on-site storage and vending services. More specifically, the vending container of the present invention is configured to communicate with an internet-based asset management platform, which provides users with the ability to browse, purchase, rent, as well as return an item of inventory stored in the container by way of a software application running on their computing device (i.e., smartphone, laptop, tablet or the like).

The plurality of items of inventory enclosed in the container may be specific to a particular business, such as maintenance, repairs, and operations (MRO)-related businesses, rental property management (e.g., for providing associated property management and maintenance of a given property), construction business, landscaping business, or the like. As such, the container may generally be placed on-premises at a given location, such as at a job site or the like, where the use and need of certain wear parts are in high demand. For example, the container may be particularly useful at a construction site, wherein the inventory may consist of fasteners (i.e., nails, screws, staples), tools (i.e., non-powered and/or powered hand tools), accessories (i.e., battery packs, etc.), and building supplies. It should be noted, however, that the container may be useful at any type of site and for any type of business. Accordingly, for those businesses that consume parts as a normal course of revenue generation, an objective would be to place secured inventory on-site and allow employees and/or customers draw from the inventory in an on-demand fashion. Therefore, the present invention addresses the shortcomings of a physical brick and mortar store. For example, as opposed to requiring an employee to travel from a site to a business when certain items are needed, the employee need only interact with their computing device (i.e., tablet, smartphone, etc.) and, via interaction with a software application associated with the asset management platform, the employee is able to simply browse for and purchase and/or rent the item(s) of their choice that are readily available via the vending container that is placed on-site.

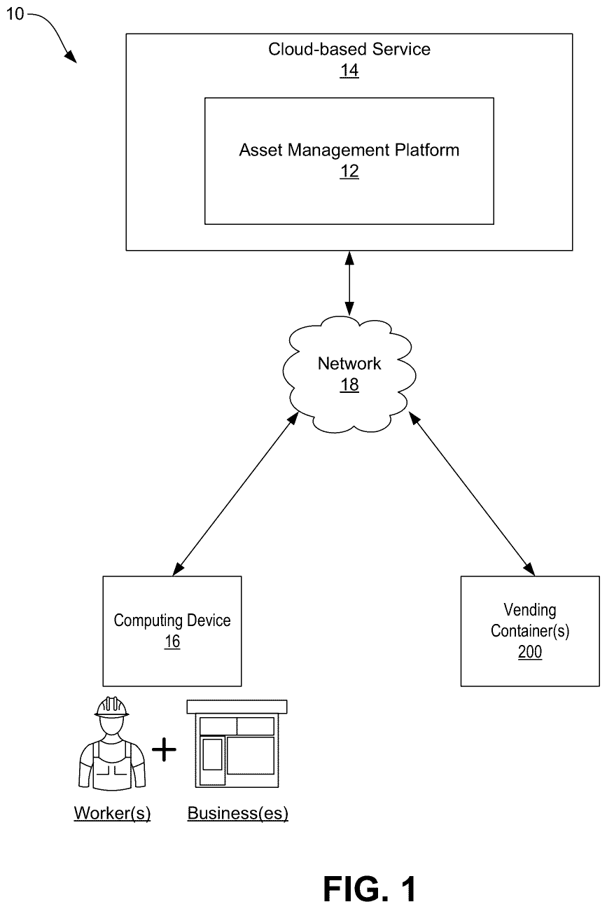

FIG. 1 is a block diagram illustrating one embodiment of an exemplary system 10 for providing users with access to one or more vending container. The system 10 includes an asset management platform 12 embodied on an internet-based computing system/service. For example, the asset management platform 12 may be embodied on a cloud-based service 14. The asset management platform 12 is configured to communicate and share data, specifically regarding inventory required for several businesses such as property maintenance and management, landscaping, construction and the like, to users via the computing device 16 over the network 18. For example, the asset management platform 12 may generally be embodied in a similar manner, function in a similar manner, and provide similar information as the asset management systems and methods described in U.S. Patent Publication No. 2016/0357876 titled “Asset Communication Hub”, the content of which is incorporated herein by reference in its entirety. The system 10 is further configured to communicate and share data with the asset management platform 12 as well as the worker(s), employee(s), or the like via the computing device 16 of the network 18.

The network 18 may represent, for example, a private or non-private local area network (LAN), personal area network (PAN), storage area network (SAN), backbone network, global area network (GAN), wide area network (WAN), or collection of any such computer networks such as an intranet, extranet or the internet (i.e., a global system of interconnected network upon which various applications or service run including, for exam, the World Wide Web). In alternative embodiments, the communication path between computing devices 16 and/or between the computing devices 16 and the cloud-based service 14, may be, in whole or in part, a wired connection.

The network 18 may be any network that carries data. Examples of suitable networks that may be used as network 18 include, but are not limited to, Wi-Fi wireless data communication technology, the internet, private networks, virtual private networks (VPN), public switch telephone networks (PSTN), integrated services digital networks (ISDN), digital subscriber link networks (DSL), various second generation (2G), third generation (3G), fourth generation (4G) cellular-based data communication technologies, Bluetooth radio, Near Field Communication (NFC), the most recently published versions of IEEE 802.11 transmission protocol standards, other networks capable of carrying data, and combinations thereof. In some embodiments, network 18 is chosen from the internet, at least one wireless network, at least one cellular telephone network, and combinations thereof. As such, the network 18 may include any number of additional devices, such as additional computers, routers, and switches, to facilitate communications. In some embodiments, the network 18 may be or include a single network, and in other embodiments the network 18 may be or include a collection of networks.

The asset management platform 12 is configured to communicate and share data with computing devices 16 associated with a work or employee (or any particular user associated with the business). Accordingly, the computing device 16 may be embodied as any type of device for communicating with the asset management platform 12 and cloud-based service 14, and/or other user devices over the network 18. For example, the computing device may be embodied as, without limitation, a computer, a desktop computer, a personal computer (PC), a tablet computer, a laptop computer, a notebook computer, a mobile computing device, a smart phone, a cellular telephone, a handset, a messaging device, a work station, a distributed computing system, a multiprocessor system, a processor-based system, and/or any other computing device configured to store and access data, and/or to execute software and related applications consistent with the present disclosure. In the embodiments described here, the computing device 16 is generally embodied as a smartphone or tablet. However, it should be noted that one or more devices 16 may include a computer, a desktop computer, a personal computer (PC), a tablet computer, a laptop computer, a notebook computer, and the like.

It should be noted that embodiments of the system 10 of the present disclosure include computer systems, computer operated methods, computer products, systems including computer-readable memory, systems including a processor and a tangible, non-transitory memory configured to communicate with the processor, the tangible, non-transitory memory having stored instructions that, in response to execution by the processor, cause the system to perform steps in accordance with the disclosed principles, systems including non-transitory computer-readable storage medium configured to store instructions that when executed cause a processor to follow a process in accordance with the disclosed principles, etc.

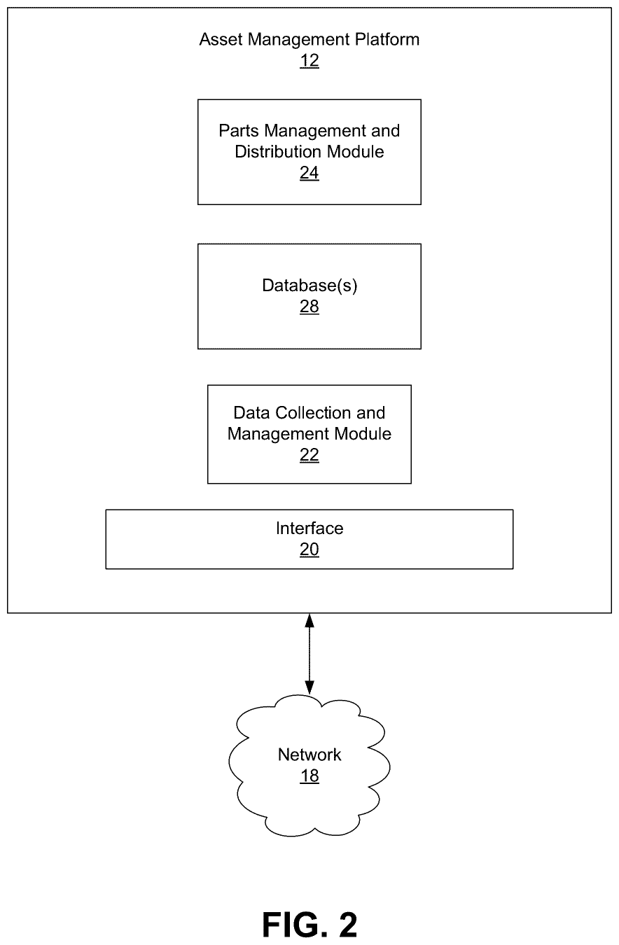

FIG. 2 is a block diagram illustrating the asset management platform 12 in greater detail. As shown, the asset management platform 12 may include an interface 20, a data collection and management module 22, a parts management and distribution module 24, and various databases 28 for storage of data. The databases 28 may include databases for storage of content related items associated with a particular business, such as maintenance, repairs, and operations (MRO)-related businesses, rental property management (e.g., for providing associated property management and maintenance of a given property), construction business, landscaping business, or the like. For example, for a given business, certain internal operations may be required, including MRO-type services for that business. MRO-type services may include the upkeep of a plant or facility, including the maintenance of the facility, the systems that run inside of it, and the assets and equipment used inside the facility to produce the main business output. As such, the items needed may include certain wear parts necessary for the day-to-day operations of a given facility, which could include HVAC, lighting, and the like. With the example of construction services, the items may include certain wear parts that are in high demand, such as fasteners (i.e., nails, screws, staples), tools (i.e., non-powered and/or powered hand tools), accessories (i.e., battery packs, drill and driver bits, saw blades, etc.), and building supplies.

The databases 28 may also include databases for storage of inventory records of a user, as well as databases for storage of client/user accounts, including any associated purchases, returns, and the like. The databases 28 may further include databases for storage of inventory data of the network of containers. In other words, the asset management platform 12 may be configured to generally monitor the status of a given container, including monitoring all transactions associated therewith, as well as the inventory of stocked parts and further manage inventory replenishment, particularly via the parts management and distribution module 24. The data collection and management module 22 may be configured to communicate and exchange data with each of the databases.

The interface 20 may generally allow a user to access data on the asset management platform 12, via a mobile software application, for example, provided on a mobile device or via a web-based portal. For instance, on accessing a mobile software application, the interface 20 may be presented to the user via their device 16. The user may then navigate a dashboard or standard platform interface so as to view data (stored in one or more of the databases) and to initiate the purchase of one or more items and subsequently picking up of the purchased items from the vending container. The user may also initiate a return of a purchased item or rented item. The software application may be for example, the Fix app offered by Fix.com, and the user can browse through various items of inventory through the said application and purchase any available item.

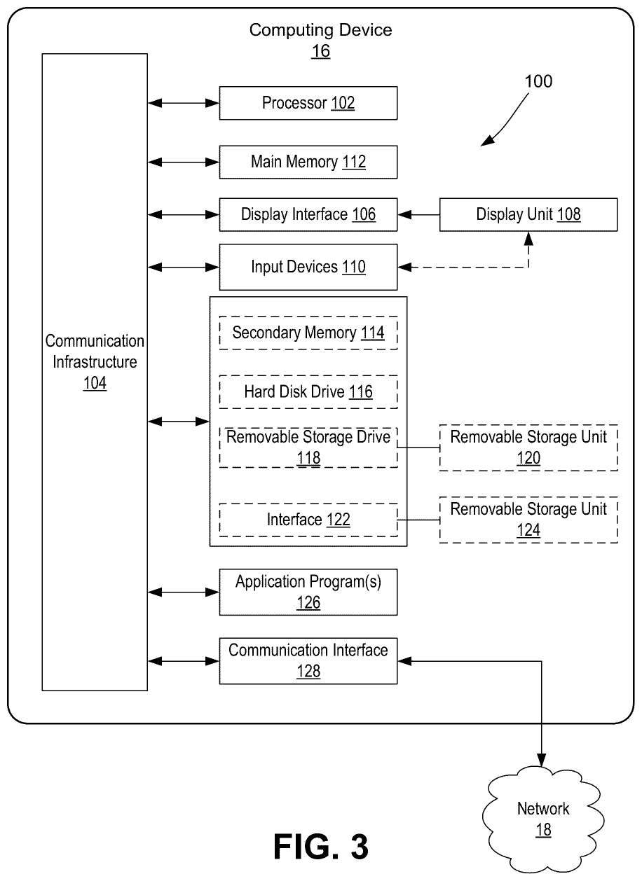

FIG. 3 is a block diagram illustrating at least one embodiment of a computing device 16 for communicating with the asset management platform 12 and providing an interface upon which the user can interact so as browse and either purchase goods or initiate a process for returning purchased items and utilizing a selected container for either vending a purchased or rented item or accepting a return of an item, such as a rented item. As previously described herein, the computing device 16 may generally be a mobile device, such as a smartphone or tablet.

The computing device 16 generally includes a computing system 100, which includes at least one processor 102. Processor 102 may be any type of processor capable of performing functions described herein. For instance, the processor may be a single or multi-core processor(s), digital signal processor, microcontroller, or other processor or processing/controlling circuit.

The computing system 100 includes a display interface 106 that forwards texts, graphics, sounds, and other data from communication infrastructure 104 (or from a frame buffer not shown) for display on display unit 108. The computing system further includes input devices 110, which may include, but is not limited to a keypad, microphone, camera. In an exemplary embodiment, the display unit 108 may include a touch-sensitive display also known as “touchscreen display” in addition to, or as an alternative to, physical push-button keyboard or the like. The touch screen may generally display graphics and text, as well as provides a user interface (e.g., but not limited to graphical user interface (GUI)) through which a user may interact with the computing device 16, such as accessing and interacting with applications executed on the device 16, including an app for providing direct user input with asset management services offered by the asset management platform.

The computing system 100 further includes main memory 112, such as random-access memory (RAM), and may also include secondary memory 114. The main memory 112 and secondary memory 114 may be embodied as any type of device or devices configured for short-term or long-term storage of data such as, for example, memory devices and circuits, memory cards, hard disk drives, solid-state drives, or other data storage devices. Similarly, the memory 112, 114 may be embodied as any type of volatile or non-volatile memory or data storage capable of performing the functions described herein.

In the illustrative embodiment, the computing device 16 may maintain one or more application programs, databases, media and/or other information in the main and/or secondary memory 112, 114. The secondary memory 114 may include, for example, a hard disk drive 116 and/or removable storage drive 118, representing a floppy disk drive, a magnetic tape drive, an optical disk drive, etc. Removable storage drive 118 reads from and/or writes to removable storage unit 120 in any known manner. The removable storage unit 120 may represents a floppy disk, magnetic tape, optical disk, etc. which is read by and written to by removable storage drive 118. As will be appreciated, removable storage unit 120 includes a computer usable storage medium having stored therein computer software and/or data.

In alternative embodiments, the secondary memory 114 may include other similar devices for allowing computer programs or other instructions to be loaded into the computing system 100. Such devices may include, for example, a removable storage unit 124 and interface 122. Examples of such may include a program cartridge and cartridge interface (such as that found in video game devices), a removable memory chip (such as an erasable programmable read only memory (EPROM), or programmable read only memory (PROM)) and associated socket, and other removable storage units 124 and interfaces 122, which allow software and data to be transferred from removable storage unit 124 to the computing system 100.

The computing system 100 further includes one or more application programs 126 directly stored thereon. The application program(s) 126 may include any number of different software application programs, each configured to execute a specific task.

The computing system 100 further includes a communications interface 128. The communications interface 128 may be embodied as any communication circuit, device, or collection thereof, capable of enabling communications between the computing device 16 external devices (e.g., the cloud-based service 14, including the asset management platform 12, as well as any given container 200). The communications interface 128 may be configured to use any one or more communication technology and associated protocols, as described above, to effect such communication. For example, the communications interface 128 may be configured to communicate and exchange data with the asset management platform 12, and/or a given vending container 200, via a wireless transmission protocol including, but not limited to, Bluetooth communication, infrared communication, near field communication (NFC), radio-frequency identification (RFID) communication, cellular network communication, the most recently published versions of IEEE 802.11 transmission protocol standards, and a combination thereof. Examples of communications interface 128 may include a modem, a network interface (such as an Ethernet card), a communications port, a Personal Computer Memory Card International Association (PCMCIA) slot and card, wireless communication circuitry, etc.

Computer programs (also referred to as computer control logic) may be stored in main memory 112 and/or secondary memory 114 or a local database on the computing device 16. Computer programs may also be received via communications interface 128. Such computer programs, when executed, enable the computing system 100 to perform the features of the present invention, as discussed herein. In particular, the computer programs, including application programs 126, when executed, enable processor 102 to perform the features of the present invention. Accordingly, such computer programs represent controllers of computer system 100.

In one embodiment where the invention is implemented using software, the software may be stored in a computer program product and loaded into the computing system 100 using removable storage drive 118, hard drive 116 or communications interface 128. The control logic (software), when executed by processor 102, causes processor 102 to perform the functions of the invention as described herein.

In another embodiment, the invention is implemented primarily in hardware using, for example, hardware components such as application specific integrated circuits (ASICs). Implementation of the hardware state machine so as to perform the functions described herein will be apparent to persons skilled in the relevant art(s).

In yet another embodiment, the invention is implemented using a combination of both hardware and software.

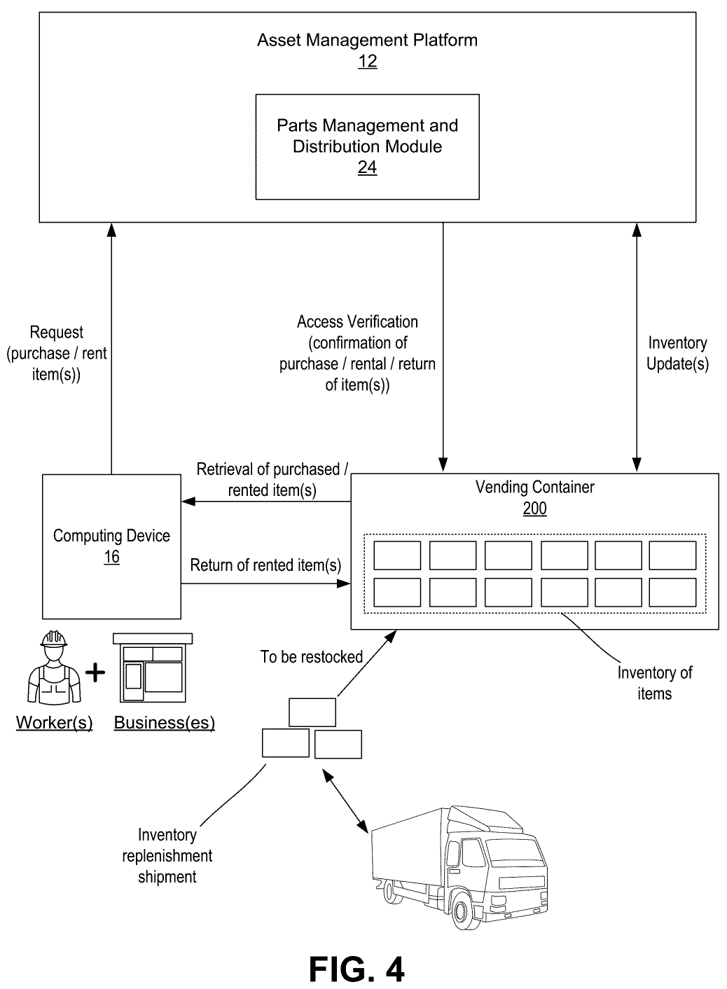

FIG. 4 is a block diagram illustrating communication and exchange of data between a user's computing device 16, the asset management platform 12, and the vending container 200. As generally understood, a specific business may request one or more vending containers for a given location (i.e., at the business itself, at a job site, or the like) and specifically request a certain inventory of items based on their needs. Accordingly, the vending container is then delivered to the given location (on-premises of the business or the jobsite) and remains on-site to allow for on-demand accessing of items as needed. The vending container arrives in a locked position, thereby maintaining security over the contents within. The container can be simply supplied with power (i.e., the container may include a standard electrical plug requiring a user to simply plug in the container to a power source). Upon being powered up, a user can interact with the container, specifically a communication module of the container to thereby set up the container to communicate over a network.

In turn, the user may access the asset management platform using their computing device 16 (via a software application). The user may initiate a transaction by purchasing or renting a specific item of inventory within the container. This creates a request which is received by the asset management platform. In turn, the asset management platform 12 is configured to identify the one or more vending containers based on the user's location and the user's profile, and further transmit the transactional data with the container. Once the vending container is located, the user can physically pick up the purchased or rented item. Similarly, in the event that a user is returning a purchased item (that they did not use) or a simply returning a rented item (by way of initiating the return on the mobile app), the user can physically return the item.

As previously described herein, the asset management platform 12 is able to (via parts management and distribution module 24) monitor the status of a given vending container, particularly the current inventory of items of a given container. This includes, monitoring all transactions associated therewith, as well as inventory of the stocked parts and further manage inventory replenishment. In other words, the platform 12 includes a database storing inventory data for any given vending container 200. Accordingly, the platform 12 is able to automatically determine when item replenishment is necessary for any given container 200 based, at least in part, on the transaction history of any given item. In turn, the platform 12 is able to automatically initiate a replenishment, which includes shipping the needed items to the particular vending container (i.e., ship the replenishment items to a given worker, employee, or the like associated with the business and the given container), at which point, the order may be billed directly to that individual (or the business) at the time of shipment, and the worker/employee can initiate a replenishment transaction upon receipt of the shipped items, and, upon fully restocking all replenishment items into the container, the worker/employee will be credited back the billed amount.

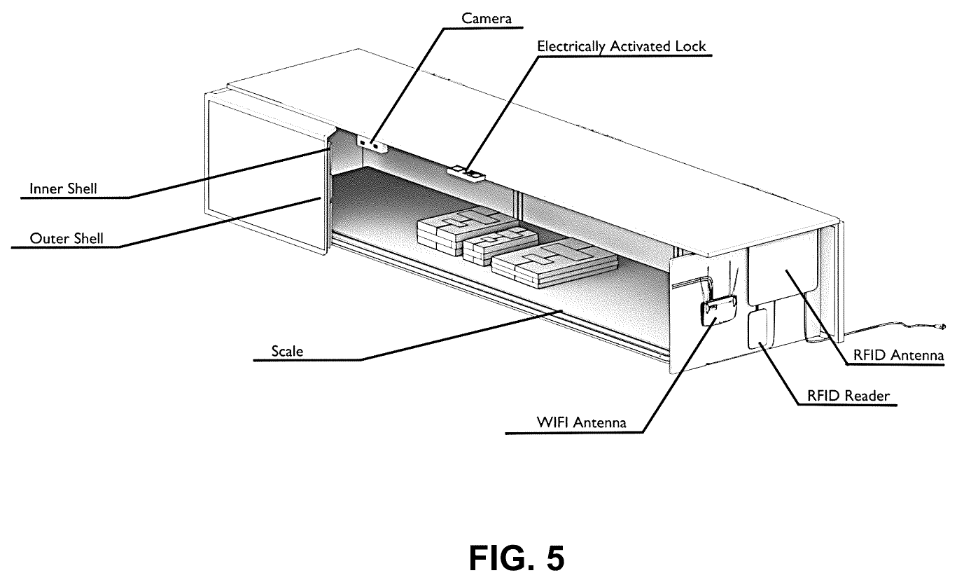

FIG. 5 is a perspective view of an exemplary embodiment of a vending container consistent with the present disclosure illustrating various components for providing on-site storage and vending services. As shown, the vending container is a standalone structure which can be placed on premises of a business. The container includes an enclosure for housing a plurality of items of inventory within. The enclosure may be comprised of a heavy duty, durable material configured to withstand blunt force impact and other attempts for illegal entry, and is further constructed to be weather resistant. It should be noted that some portions of the container enclosure are not shown so as to better illustrate internal components therein. For example, in FIG. 5, the external enclosure on the front and side portions of the container are removed to thereby illustrate the inclusion of a camera module (for capturing images) and a scale (for sensing weight) of goods within the container, as well as a wireless communication module and RFID reader and communication module.

As shown, the container includes a locking mechanism configured to communicate and transmit data with an internet-based asset management platform, over a network. When the locking mechanism is in a locked state, the items of inventory are inaccessible and thus maintained in a secured fashion. However, the locking mechanism is configured to transition to an unlocked state in response to receiving a signal associated with a user transaction, specifically a user purchase or rental of one or more items of inventory stored within the container (which is based on user interaction with an interface on the user's computing device provided via the asset management platform). As such, when the user purchases or rents one or more items of inventory via their computing device (i.e., tablet or smartphone), the internet-based asset management platform communicates and transmits data over the network to the locking mechanism. Upon receiving data from the asset management platform, the locking mechanism transitions from a locked state to an unlocked state, thereby making the inventory accessible to the user.

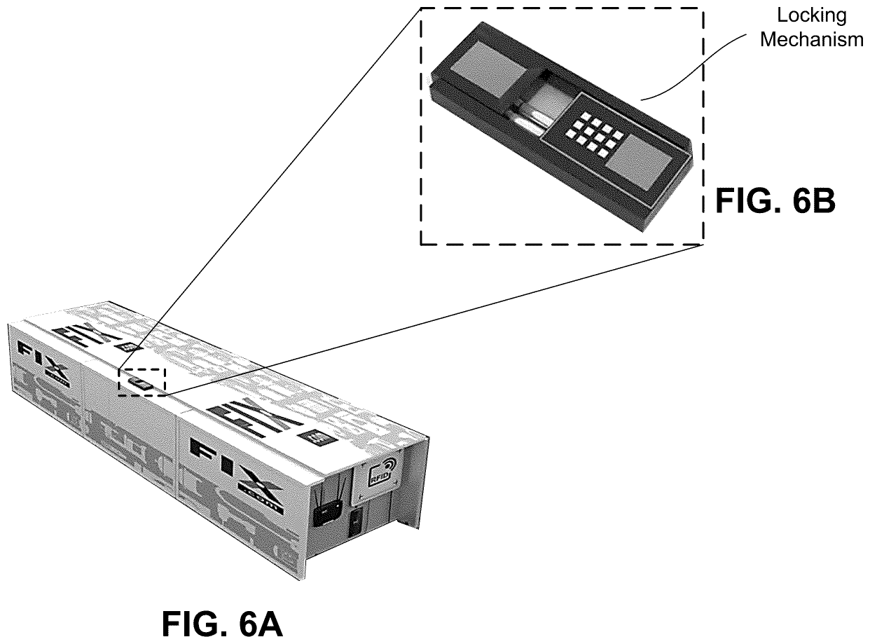

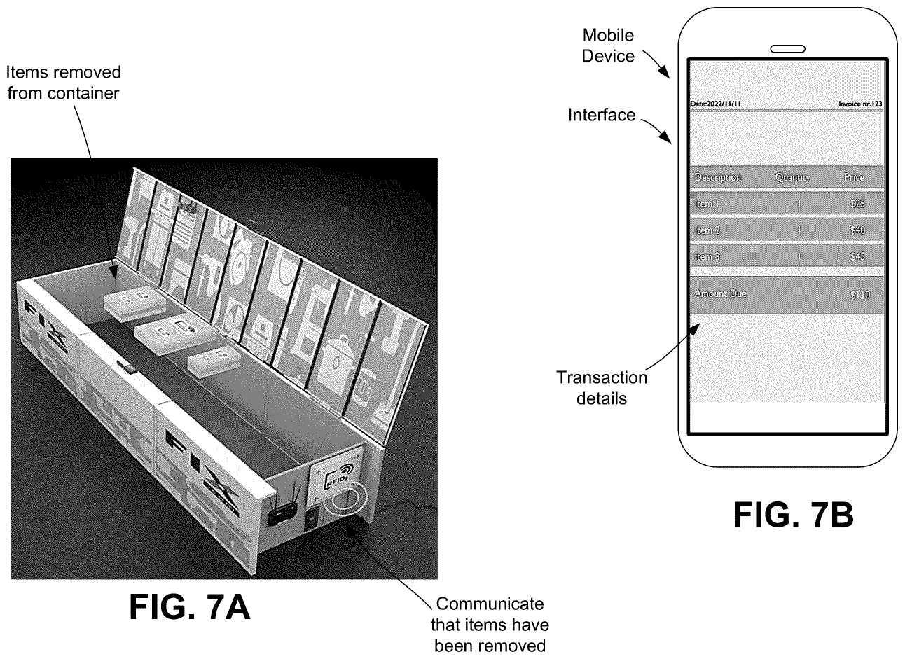

FIG. 6A is a perspective view of the vending container in which the locking mechanism (see FIG. 6B) is a locked state, in which the plurality of items of inventory within the container are inaccessible. FIG. 7A is a perspective view of the vending container in which the locking mechanism transitioned to an unlocked state (in response to transaction data received from the asset management platform and based on a user's purchase/rental of one or more items from the inventory) and one or more purchased/rented items are accessible and able to be removed from the container. FIG. 7B is a screenshot of a user's smartphone indicating that the purchased/rented items have been successfully removed from the container, thereby allowing for the transaction to be completely processed.

Similar to FIG. 5, it is noted that some portions of the container enclosure illustrated in FIGS. 6A and 7A are not shown so as to better illustrate internal components therein. For example, in FIGS. 6A and 7A, the external enclosure (i.e., end gable) on the side portion of the container is removed to thereby illustrate the inclusion of the wireless communication module and RFID reader and communication module.

As shown, the portable vending container includes a communication module allowing for wireless communication and transition of data between the locking mechanism and other components associated with the vending container and also the asset management platform. In particular, the communication module may be WiFi-enabled which allows the container and the other components associated with the vending container to be connected to a wireless network.

Any given item of inventory within the container may be radio-frequency identification (RFID) enabled to allow for recognition and subsequent movement (i.e., vending, replenishing, etc.) of a given good. In other words, each item of inventory within the container may have its own RFID tag. Furthermore, the container comprises at least one RFID antenna and reader. In the event that the user purchases or rents an item of the inventory within the container, the locking mechanism of the container unlocks. As the user removes the purchased item from the container, the RFID reader communicates with the RFID tag on the item. The user is then charged or the item purchased or rented.

It should be noted that weight of all items of the inventory present within the vending container is recorded using a scale. Upon purchasing and subsequently removing one or more item from the container, the scale records the weight of one or more items removed from the container. Therefore, by incorporating a scale, the container is configured to determine whether there is a positive correlation with a reference weight of the item. In other words, the vending container is configured to verify as to whether the one or more items purchased through the asset management platform are the items that were removed from the container.

For example, the vending container may include a plurality of stacked trays and/or shelves, such that the inventory is provided within respective trays. The weighing scale may record the weight of each item carried by each tray such that each item has its own reference weight. Once one or more items from a specific tray are purchased and removed, the weighing scale records the weight of the tray. A positive correlation is then made to the reference weight of the item purchased.

To further verify the identity of one or more items being removed, the container comprises a camera to record one or more pictures of the items removed. Removal of one or more items purchased from the container concludes the transaction and the container relocks.

In the event that a user is returning a rented item or because the user purchased an incorrect item, the container is configured to operate generally in a similar manner as when one or more item is vended to the use (i.e., when an item is purchased and is being picked up). For example, the user may initiate the return of an item via the internet-based asset management platform. The internet-based asset management system communicates and transmits data to the locking mechanism and, upon data transmission, the locking mechanism unlocks and the user can then return the item to the container. The scale then measures the weight of the item being returned. Measuring the weight enables verifying that the item being returned is indeed the item that was purchased. The scale is configured to make a positive correlation between the item the user purchased with the item being returned in order to make the verification. To further verify that the item being returned is the correct item, the camera records one or more pictures of the item being returned. Furthermore, as the item is being placed by the user in the container, the RFID reader communicates with the RFID tag on the item and a refund of the amount charged to the user is initiated.

In addition to vending goods and accepting returned goods, the inventory of a given container is configured to be replenished. More specifically, the specific inventory of any given container can be managed by the asset management platform. It may be determined at any given time that certain items need to be replenished (i.e., the number of available items is low in a given container). As such, items can be delivered on-site to a customer associated with that given site, and, in turn, the customer can interact with the interface to initiate an inventory replenishment and then physically place such items into the container. Again, by use of the scale, camera, and RFID tag reading, the container is able to verify that the items have been placed within the container and the inventor has been replenished.

Accordingly, the vending container of the present invention provides a number of advantages over current options. In particular, the container is configured to cooperatively function with an internet-based asset management platform and thus enable users to browse, purchase, rent, and/or return items at their convenience, particularly those items that are most essential to the business and the type of work that is being performed on-site.

As used in any embodiment herein, the term “module” may refer to software, firmware and/or circuitry configured to perform any of the aforementioned operations. Software may be embodied as a software package, code, instructions, instruction sets and/or data recorded on non-transitory computer readable storage medium. Firmware may be embodied as code, instructions or instruction sets and/or data that are hard-coded (e.g., nonvolatile) in memory devices. “Circuitry”, as used in any embodiment herein, may comprise, for example, singly or in any combination, hardwired circuitry, programmable circuitry such as computer processors comprising one or more individual instruction processing cores, state machine circuitry, and/or firmware that stores instructions executed by programmable circuitry. The modules may, collectively or individually, be embodied as circuitry that forms part of a larger system, for example, an integrated circuit (IC), system on-chip (SoC), desktop computers, laptop computers, tablet computers, servers, smartphones, etc.

Any of the operations described herein may be implemented in a system that includes one or more storage mediums having stored thereon, individually or in combination, instructions that when executed by one or more processors perform the methods. Here, the processor may include, for example, a server CPU, a mobile device CPU, and/or other programmable circuitry.

Also, it is intended that operations described herein may be distributed across a plurality of physical devices, such as processing structures at more than one different physical location. The storage medium may include any type of tangible medium, for example, any type of disk including hard disks, floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic and static RAMs, erasable programmable read-only memories (EPROMs), electrically erasable programmable read-only memories (EEPROMs), flash memories, Solid State Disks (SSDs), magnetic or optical cards, or any type of media suitable for storing electronic instructions. Other embodiments may be implemented as software modules executed by a programmable control device. The storage medium may be non-transitory.

As described herein, various embodiments may be implemented using hardware elements, software elements, or any combination thereof. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth.

Reference throughout this specification to “one embodiment” or “an embodiment” means that a particular feature, structure, or characteristic described in connection with the embodiment is included in at least one embodiment. Thus, appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The term “non-transitory” is to be understood to remove only propagating transitory signals per se from the claim scope and does not relinquish rights to all standard computer-readable media that are not only propagating transitory signals per se. Stated another way, the meaning of the term “non-transitory computer-readable medium” and “non-transitory computer-readable storage medium” should be construed to exclude only those types of transitory computer-readable media which were found in In Re Nuijten to fall outside the scope of patentable subject matter under 35 U.S.C. § 101.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents.

### INCORPORATION BY REFERENCE

References and citations to other documents, such as patents, patent applications, patent publications, journals, books, papers, web contents, have been made throughout this disclosure. All such documents are hereby incorporated herein by reference in their entirety for all purposes.

### EQUIVALENTS

Various modifications of the invention and many further embodiments thereof, in addition to those shown and described herein, will become apparent to those skilled in the art from the full contents of this document, including references to the scientific and patent literature cited herein. The subject matter herein contains important information, exemplification and guidance that can be adapted to the practice of this invention in its various embodiments and equivalents thereof.

1. A portable vending container for providing on-site storage and vending services, the vending container comprising:
an enclosure for housing a plurality of items of inventory within; and
at least a locking mechanism configured to transition between a locked state, in which the plurality of items of inventory are inaccessible, and an unlocked state, in which one or more the items of inventory are accessible and can be removed from the enclosure,
wherein the locking mechanism is configured to communicate and transmit data, over a network, with an internet-based asset management platform, and transition from the locked state to the unlocked state in response to transmission of transactional data associated with a user purchasing or renting one or more items of inventory based on user interaction with an interface on said user's computing device provided via the asset management platform.

2. The vending container of claim 1, wherein the interface is provided via a software application installed on the user's computing device.

3. The vending container of claim 2, wherein user interaction with the software application on their computing device allows the user to perform one or more transactions associated with the plurality of items of inventory, the one or more transactions selected from the group consisting of: purchasing of one or more items, renting of one or more items, and returning of one or more items.

4. The vending container of claim 1, wherein the container comprises a communication module allowing for wireless communication and transmission of data between the locking mechanism and other components associated with the vending container and the asset management platform.

5. The vending container of claim 4, wherein the communication module is WiFi-enabled thereby allowing the container, including components associated therewith, to be connected to a wireless network.

6. The vending container of claim 1, wherein the container comprises at least one radio-frequency identification (RFID) antenna and reader.

7. The vending container of claim 6, wherein each item of inventory within the container comprises an RFID.

8. The vending container of claim 7, wherein the RFID reader is configured to communicate with an RFID tag of any given associated item of inventory tag thereby allowing for recognition of removal of a given item of inventory from the container and placement of a given item of inventory into the container.

9. The vending container of claim 8, wherein a transaction is fully completed upon complete removal of one or more purchased and/or rented items from the container and/or upon complete placement of one or more returned items into the container.

10. The vending container of claim 1, wherein the container comprises at least one camera configured to capture one or more images of any given item of inventory that is removed from the container or placed into the container.

11. The vending container of claim 1, wherein the container comprises a scale configured to measure a weight of each item of inventory.

12. The vending container of claim 11, wherein a current total weight of all items of inventory within the container is determined prior to and after a transaction takes place.

13. The vending container of claim 12, wherein upon complete removal of one or more purchased and/or rented items from the container, the scale is configured to determine an updated total weight of all items of inventory remaining with the container and the transaction is verified upon the updated total weight having a value that is the current total weight minus the weight of the purchased and/or rented items.

14. The vending container of claim 12, wherein upon placement of all replenishing items within the container, the scale is configured to determine an updated total weight of all items of inventory currently within the container the transaction is verified upon the updated total weight having a value that is the current total weight plus the weight of the replenishing items.

15. The vending container of claim 1, wherein the container is configured to communicate and transmit inventory data with the asset management platform, wherein the inventory data associated with the number of any given item presently stored within the container and the asset management platform is configured to automatically order and deliver additional items to be stocked within the container.
